(19) United States
(12) Patent Application Publication
(10) Pub. No.: US 2019/0238550 A1
(43) Pub. Date: Aug. 1, 2019

(54) PERMISSION CONTROL METHOD, APPARATUS AND SYSTEM FOR BLOCK CHAIN, AND NODE DEVICE

(71) Applicant: CLOUDMINDS (SHENZHEN) ROBOTICS SYSTEMS CO., LTD., Shenzhen (CN)

(72) Inventors: Yueyang ZHANG, Shenzhen (CN); Hui XIE, Shenzhen (CN)

(21) Appl. No.: 16/316,951

(22) PCT Filed: Dec. 26, 2016
(86) PCT No.: PCT/CN2016/112129

§ 371 Date: Jan. 10, 2019

(51) Int. Cl. H04L 29/06; H04L 9/06; H04L 29/08

(52) U.S. Cl. CPC H04L 63/102; H04L 63/105; H04L 67/1055; H04L 63/0892; H04L 67/1046; H04L 9/0637

(57) ABSTRACT

A permission control method, apparatus and system for a blockchain, and a node device. The method comprises: writing a preset correspondence between account roles and permissions into a block of a blockchain; determining a role of a target account configured to a user node to be added to the blockchain; and controlling, according to the correspondence and the role of the target account, a permission of the user node configured with the target account. In the method, by setting roles and permissions of blockchain accounts, user nodes configured with different accounts perform corresponding operations according to roles and permissions of the user nodes, so that only accounts having corresponding permissions can access a blockchain network, synchronize data on a blockchain and acquire data within a permission range; blockchain data is protected, and the security and privacy of the blockchain data are ensured.

### FIELD OF THE INVENTION

The present disclosure relates to information technology field, in particular to a permission control method, apparatus and system for a blockchain, and a node device.

### BACKGROUND OF THE INVENTION

A blockchain is a decentralized distributed database system in which all nodes in a blockchain network participate in maintenance. It is composed of a series of data blocks generated on the basis of cryptography, and each data block is a block in the blockchain. According to the sequence of generation time, the blocks are linked together orderly to from a data chain, which is vividly called the blockchain. The blockchain has its own unique block generation, transaction generation and verification protocols, and has security features such as unchangeability, unforgeability, and full traceability.

In the related art, nodes of the blockchain establish a connection with each other through a P2P network, and each newly added node will synchronize all data in the current chain. Blockchain data is completely public to each node, and a node can freely view information of any transaction in any block.

Thus, for the blockchain in the related art, as the addition of a node to the chain is not restricted, and data on the chain is completely open, it is suitable for some public and non-privacy information storage, but not suitable for information storage where data on the blockchain has privacy.

### SUMMARY

The present disclosure provides a permission control method, apparatus and system for a blockchain, and a node device, mainly for overcoming problems existing in the related art.

In a first aspect of the present disclosure, a permission control method for a blockchain is provided, comprising:

writing a preset correspondence between account roles and permissions into a block of a blockchain;

determining a role of a target account configured to a user node to be added to the blockchain; and

controlling, according to the correspondence and the role of the target account, a permission of the user node configured with the target account.

In a second aspect, a permission control apparatus for a blockchain is provided, comprising:

a correspondence writing module configured to write a preset correspondence between account roles and permissions into a block of a blockchain;

a node role determination module configured to determine a role of a target account to be added to the blockchain; and

a permission control module configured to control, according to the correspondence and the role of the target account, a permission of the user node configured with the target account.

In a third aspect, a permission control system for a blockchain node is provided, comprising:

an administrator node and a user node, wherein the administrator node is a node configured with an administrator account in a blockchain network;

the administrator node is configured to write a preset correspondence between account roles and permissions into a block of a blockchain; determine a role of a target account configured to the user node to be added to the blockchain; and control, according to the correspondence and the role of the target account, a permission of the user node configured with the target account.

In a fourth aspect, a computer program product is provided, wherein the computer program product contains a computer program executable by a programmable device, and the computer program has a code portion for performing the above-mentioned permission control method for a blockchain node when executed by the programmable device.

In a fifth aspect, a non-transitory computer readable storage medium is provided, wherein the non-transitory computer readable storage medium comprises one or more programs for performing the above-mentioned permission control method for a blockchain node.

In a sixth aspect, a node device is provided, comprising:

the above-mentioned non-transitory computer readable storage medium; and

one or more processors used for executing the program in the non-transitory computer readable storage medium.

In the embodiments of the present disclosure, by setting roles and permissions of blockchain accounts, user nodes configured with different accounts perform corresponding operations according to roles and permissions of the user nodes, so that only accounts having corresponding permissions can access a blockchain network, synchronize data on a blockchain and acquire data within a permission range; blockchain data is protected, and the security and privacy of the blockchain data are ensured.

It should be understood that the above general description and the subsequent detailed description are illustrative and explanatory only, and the present disclosure is not limited thereto.

Other features and advantages of the present disclosure will be described in detail in the following detailed description.

### BRIEF DESCRIPTION OF THE DRAWINGS

The drawings herein are incorporated into the specification and form part of the specification, showing embodiments in conformity with the present disclosure, and serving to explain the principles of the present disclosure together with the description.

FIG. 1 is a schematic diagram of a blockchain network in the related art.

FIG. 2 is a schematic diagram of a blockchain network according to an embodiment of the present disclosure;

FIG. 3 is a flow diagram of a permission control method for a blockchain according to an embodiment of the present disclosure;

FIG. 4 is a schematic diagram of a block header data structure according to an embodiment of the present disclosure;

FIG. 5 is a schematic diagram of a change in the correspondence between roles and permissions according to an embodiment of the present disclosure;

FIG. 6 is a flow diagram of assigning a role to an account according to an embodiment of the present disclosure;

FIG. 7 is a flow diagram of establishing a P2P connection between user nodes according to an embodiment of the present disclosure;

FIG. 8 is a flow diagram of blockchain synchronization according to an embodiment of the present disclosure;

FIG. 9 is a schematic diagram of processing a new block or transaction according to an embodiment of the present disclosure;

FIG. 10 is a schematic diagram of forwarding a new block or transaction according to an embodiment of the present disclosure;

FIG. 11 is a block diagram of a permission control apparatus for a blockchain according to an embodiment of the present disclosure;

FIG. 12 is a block diagram of a device for a permission control method for a blockchain according to an exemplary embodiment;

FIG. 13 is a hierarchical schematic diagram of an operating system according to an embodiment of the present disclosure.

### DETAILED DESCRIPTION OF THE EMBODIMENTS

The specific embodiments of the present disclosure will be described in detail below with reference to the drawings. It should be understood that the specific embodiments described herein are merely used for illustrating and explaining the present disclosure rather than limiting the present disclosure.

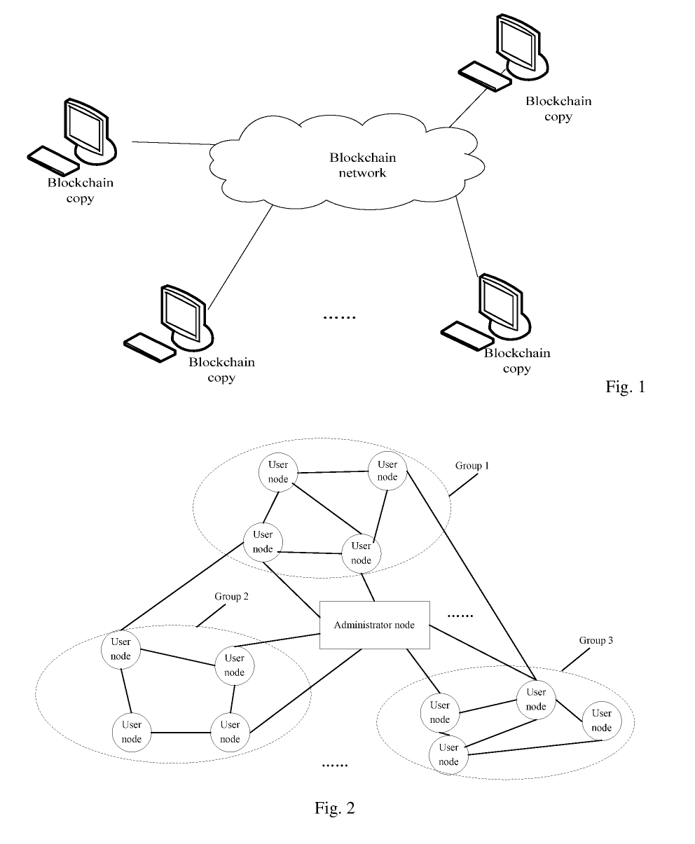

See FIG. 1, which is a schematic diagram of a blockchain network in the related art. Nodes of a blockchain establish a connection with each other through a P2P network, and each node added to the blockchain network can synchronize all data on the current blockchain, so that several copies of blockchain data are saved to multiple nodes on the blockchain.

In the embodiments of the present disclosure, in order to protect data in the blockchain, role differentiation and permission setting are performed on different user nodes configured with different accounts, so that user nodes configured with different accounts have different permissions in accessing a blockchain, synchronizing data on the blockchain, and accessing data in the blockchain, etc.

See FIG. 2, which is a schematic diagram of a blockchain network according to an embodiment of the present disclosure. Each user node in the blockchain network is configured with an account, and different accounts have different roles and permissions, thereby enabling user nodes of the blockchain network to have roles and permissions corresponding to the accounts.

Blockchain data writing: a blockchain node writes data to a blockchain by issuing a transaction to a blockchain network. The transaction comprises: a transaction data packet generated by the blockchain node according to a preset transaction data format pair, and a digital signature on the transaction data packet by using a private key of the blockchain node, wherein the digital signature is used for proving the identity of a user of the blockchain node; then, after the transaction is issued to the blockchain network, a “miner” (i.e., a blockchain node that implements a PoW (Proof Of Work) consensus competition mechanism) in the blockchain network records the transaction into a new block generated in the blockchain and issues the new block to the blockchain network; after the new block and the transaction recorded by the new block are verified and accepted by other blockchain nodes, the transaction recorded by the new block is written into the blockchain, wherein a new block in the blockchain is periodically generated by the above-mentioned “miner” through the implementation of a consensus competition mechanism such as PoW or PoS, so the time interval for generating new blocks is usually related to the above-mentioned preset technical requirements, and the time interval at which the blockchain generates new blocks can be changed by setting different preset technical requirements.

In an embodiment of the present disclosure, user nodes configured with accounts of a same role and permission may be divided into one group, for example, group 1, group 2, group 3, . . . as shown in FIG. 2. The number of user nodes in each group can be one or more.

In an embodiment of the present disclosure, the account roles and the corresponding permission information are as shown in Table 1.

TABLE 1

| | Permission | | | | |
|---|---|---|---|---|---|
| | | | | Accessing | Accessing |
| | Accessing a | Synchronizing | | data of the | data related to |
| Account | blockchain | blockchain | Accessing all | current | the current |
| role | network | data | data | group | account |
| Administrator | ✓ | ✓ | ✓ | ✓ | ✓ |
| Group 1 | ✓ | ✓ | | ✓ | ✓ |
| Group 2 | ✓ | ✓ | | | ✓ |
| . . . | | | | | |

In the embodiments of the present disclosure, an administrator node is a user node configured with an administrator account in a blockchain network, and may perform at least one or more of the following operations: determining a role of an account, changing permission information of accounts, creating a block, etc. Referring to Table 1, permissions of an administrator comprises: accessing a blockchain network, synchronizing blockchain data, accessing all data, accessing data of the current group, and accessing data related to the current account.

Each of group 1, group 2, . . . includes one or more user nodes configured with corresponding user accounts, and the user nodes can participate in the creation of blocks and the like. User nodes in the same group have the same permissions, comprising one or more of the following permissions: accessing a blockchain network, synchronizing blockchain data, accessing all data, accessing data of the current group, and accessing data related to the current account.

Accessing a blockchain network in Table 1 means that a user node configured with a corresponding account can be allowed to access the blockchain network. Synchronizing blockchain data means that a user node configured with a corresponding account can synchronize a blockchain to save a data copy of the blockchain to local. Accessing all data means that a user node configured with a corresponding account can access (read) all data in a block of a blockchain. Accessing data of the current group means that a user node configured with a corresponding account can access related data of other user nodes in the current group. Accessing data related to the current account means that a user node configured with a corresponding account can access the data related to the account of the user node.

In the embodiments of the present disclosure, roles and permissions corresponding to accounts may be set and changed according to actual conditions.

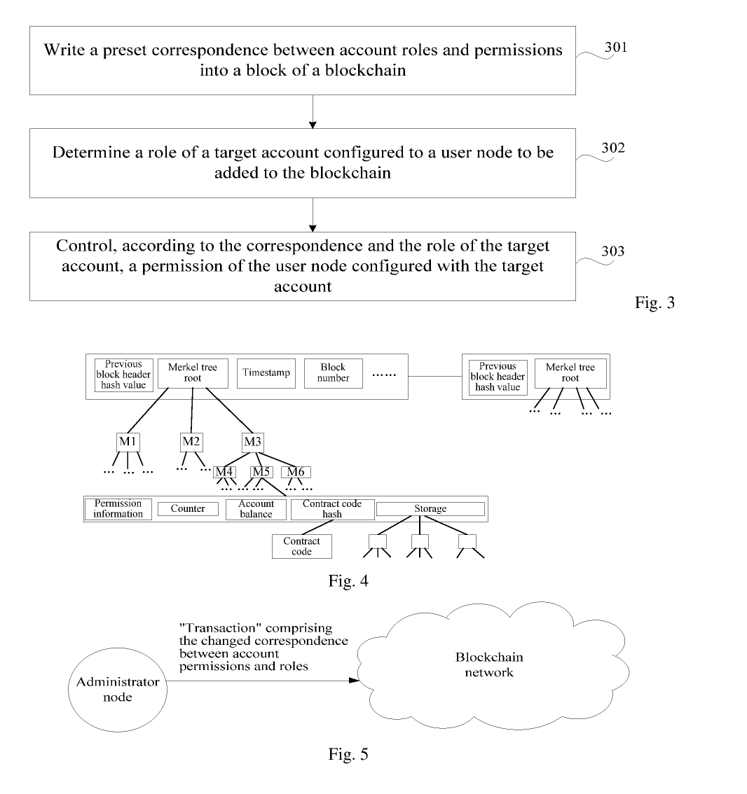

FIG. 3 is a flow diagram of a permission control method for a blockchain node according to an embodiment of the present disclosure. The method comprises the following steps:

In the step 301, writing a preset correspondence between account roles and permissions into a block of a blockchain;

In the step 302, determining a role of a target account configured to a user node to be added to the blockchain; and

In the step 303, controlling, according to the correspondence and the role of the target account, a permission of the user node configured with the target account.

In the embodiments of the present disclosure, each account is defined by a pair of keys: a private key and a public key. An account is indexed by an address, and the address is derived from a public key. The one-way encryption algorithm is used to calculate a 20-byte address for the public key as an account address. Wherein the private key is mastered by a user and not issued to a blockchain network, the public key and account address can be freely issued to the blockchain network. It should be understood that there is no one-to-one correspondence between an account and a user node in the blockchain, and the private key corresponding to an account can be used on any user node of the blockchain. For example, for an administrator account, any user node configured with the private key of the administrator account is an administrator node, while the public key or account address of the administrator account has been issued to the blockchain network.

In the embodiments of the present disclosure, account attributes (status) of each account include the following attribute fields: permission information, account balance, counter, account contract code (if any), account storage (default as empty). The permission information field is used to identify a role of an account and/or a corresponding permission. The counter is used to determine that each transaction can only be processed once. The account balance is the balance of the blockchain as a digital currency storage account. If an account is a contract account, the account attribute includes an account contract code. Each time the contract account receives a message, a code inside the contract is activated, allowing it to read and write to the internal storage, and send other messages or create a contract.

Referring to FIG. 4, in the embodiments of the present disclosure, account attributes of an account are saved through a Merkel tree. The tree root of the Merkel tree is saved in a block header. The block header data structure at least comprises: a previous block header hash value, a Merkel tree root, a timestamp, a block number, etc. Under the Merkel tree root, each leaf node beginning with M represents an account.

In an embodiment of the present disclosure, a correspondence between account roles and permissions in the above Table 1 is written into permission information of account attributes of a block of a blockchain, and roles of accounts are written into permission information of account attributes of a block (for example, a block different from writing correspondence between account roles and permissions). It should be understood that roles and permissions of each account can also be written together into a block, and permissions of accounts can be obtained according to the block that stores roles and permissions of accounts. In an embodiment of the present disclosure, in order to save storage space and facilitate management of account permissions, account roles are written into a block. Since the correspondence between account roles and permissions has been stored in a block, the permissions of the accounts can be obtained according to the account roles and the correspondence in the block.

In an embodiment, in step 301, the correspondence between account roles and permissions in Table 1 can be written into a block of a blockchain at least by the following three approaches:

Approach 1, a user node the role of which is an administrator writes the information in Table 1 directly into the genesis block (i.e. the first block) without going through the mining process.

In an embodiment, the role of a user node is an administrator, that is, the user node is configured with an administrator account. The administrator account can be preset, that is, according to a preset rule, a public key or an account address is generated as an administrator account.

Approach 2, in other embodiments, the correspondence between account roles and permissions in Table 1 is used as fixed configuration information of a system, that is, it has been written in advance to a client system run by a user node; when the user node starts the system, the genesis block including information shown in Table 1 can be obtained.

Approach 3, any user node or designated user node in a blockchain network, issues a “transaction” that includes information shown in Table 1; after user nodes in the blockchain network compete for the permission to create a block, the information shown in Table 1 is written to the permission information field of the block header of the block.

When the above approaches 1 and 2 are adopted, the information in Table 1 is written into the block as the account attribute of a special account. The account address of the special account may be all 0s, for example, a 20-byte address that is all 0s. Thus, the block header of the genesis block includes a special account, and the permission information in the account attributes of the account includes the information shown in Table 1 above.

In an embodiment of the present disclosure, after the information in Table 1 is written into a block, it can serve as a default permission of a user node for accessing a blockchain. An administrator node can change the default permission, and the change process will be described in detail later.

In the embodiments of the present disclosure, since the roles and permissions of different accounts are different, in the processes such as a user node configured with a corresponding account accesses a blockchain, a user node configured with a corresponding account synchronizes data, and a user node configured with a corresponding account accesses data, the permission of the account configured to the user node will be confirmed, so that the user node is controlled in accessing and reading, etc., and data in the blockchain is protected.

In the embodiments of the present disclosure, by changing the block header data structure, adding a field for distinguishing roles and permissions of different accounts into account attributes of the block header is easy to implement, so that a blockchain node is more efficient in identifying an account permission, the protection of blockchain data is achieved, and the security and privacy of the blockchain data are ensured.

Change of Roles and Permissions Corresponding to Accounts

Referring to FIG. 5, an administrator node can change the correspondence between roles and permissions in Table 1, and change roles of accounts. When an administrator node makes a change, a “transaction” is issued to a blockchain network, and the “transaction” comprises changed information, such as, changed correspondence between roles and permissions, and changed roles of accounts. A miner node in the blockchain network performs mining to store the changed information in a newly created target block of the blockchain. If the correspondence in Table 1 is stored in the target block after being changed, the correspondence between permissions and roles can be queried through a special account in the target block in the subsequent process when querying the correspondence is required.

A role is assigned to an account and a user node configured with a corresponding account accesses a blockchain

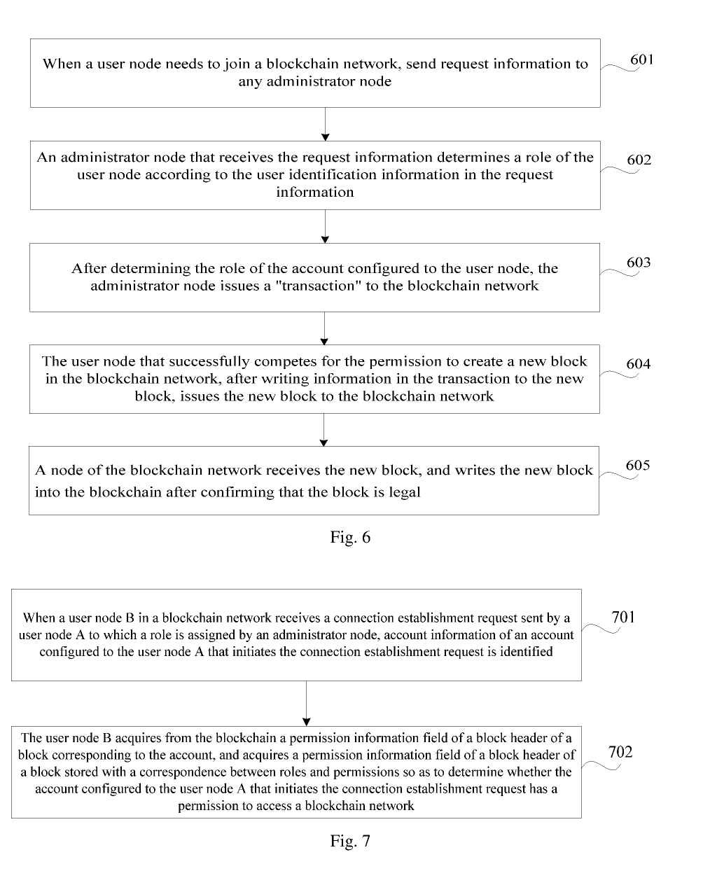

Based on the above block header data structure, referring to FIG. 6, in the embodiments of the present disclosure, a user node added to a blockchain needs to be configured with an account to which a role has been assigned, and the role is stored in a block according to the above block header data structure.

Initially, a preset number of administrator nodes can be predetermined in a blockchain network. Predetermining here refers to assigning an administrator account to a user node to make it an administrator node. The preset number of administrator nodes establish a P2P connection with each other to form an initial blockchain network. According to the above embodiments, the preset number of administrator nodes store at least one block, and the block includes the information shown in Table 1 above. It should be understood that the preset number of administrator nodes may be one or more.

In step 601, when a user node needs to join a blockchain network, request information is sent to any administrator node. The request information at least comprises an account address of an account configured to the user node, and user identification information. In an embodiment, the account address is generated by the user node. The user identification information may be one or more of the following information: user name, user number, user code, and the like.

In step 602, an administrator node that receives the request information determines a role of the account configured to the user node according to the user identification information in the request information. In an embodiment, the administrator node determines the legality of the user node according to the account and/or the user identification information, and determines a role of the account configured to the user node after determining that the user is legal. The administrator node may determine the role of the account configured to the user node according to a preset rule, for example, the preset rule may be a correspondence between the user identification information and the role.

In step 603, after determining the role of the account configured to the user node, the administrator node issues a “transaction” to the blockchain network, wherein the transaction comprises an account address and role of the account configured to the user node that requests access to the blockchain network.

In step 604, the user node that successfully competes for the permission to create a new block in the blockchain network, after writing information in the transaction to the new block, issues the new block to the blockchain network, wherein the role is written to a permission information field of a block header.

In step 605, a node of the blockchain network receives the new block, and writes the new block into the blockchain after confirming that the block is legal.

In the embodiments of the present disclosure, roles of accounts configured to user nodes may be assigned before the access to the blockchain. As the correspondence between roles and permissions has been stored in a block, permissions of accounts configured to user nodes can be determined according to the block that stores the correspondence between roles and permissions, and the block that stores account roles of accounts configured to user nodes.

It should be understood that an administrator node may assign a role to an account configured to a user node that sends request information. If a node that receives the request information is not an administrator node, the node does not process the request information, but sends the request information to a node that is connected thereto so that the request information is finally received by an administrator node.

In the above steps 601-605, after the role is assigned to the account configured to the user node, a P2P connection establishment request may be initiated to the user node in the blockchain network.

See FIG. 7, which is a flow diagram of establishing a P2P connection between user nodes according to an embodiment of the present disclosure.

In step 701, when a user node B in a blockchain network receives a connection establishment request sent by a user node A to which a role is assigned by an administrator node, account information of an account configured to the user node A that initiates the connection establishment request is identified. It should be understood that the user node B can be an administrator node or any user node added to the blockchain network.

In step 702, the user node B acquires from the blockchain a permission information field of a block header of a block corresponding to the account, and acquires a permission information field of a block header of a block stored with a correspondence between account roles and permissions (the role(s) of account(s) is (are) stored in the permission information field) so as to determine whether the account configured to the user node A that initiates the connection establishment request has a permission to access a blockchain network.

In an embodiment, if the account information of the account configured to the user node A is not queried, or the permission of the account configured to the user node A does not comprises accessing a blockchain network, the user node B does not establish a P2P connection with the user node A. If the account configured to the user node has the permission to access a blockchain network, a P2P connection is established thereto.

After the user node accesses the blockchain network, operations such as blockchain synchronization and data access can be performed according to permissions of the account configured to the user node.

User Node Synchronizes Blockchain

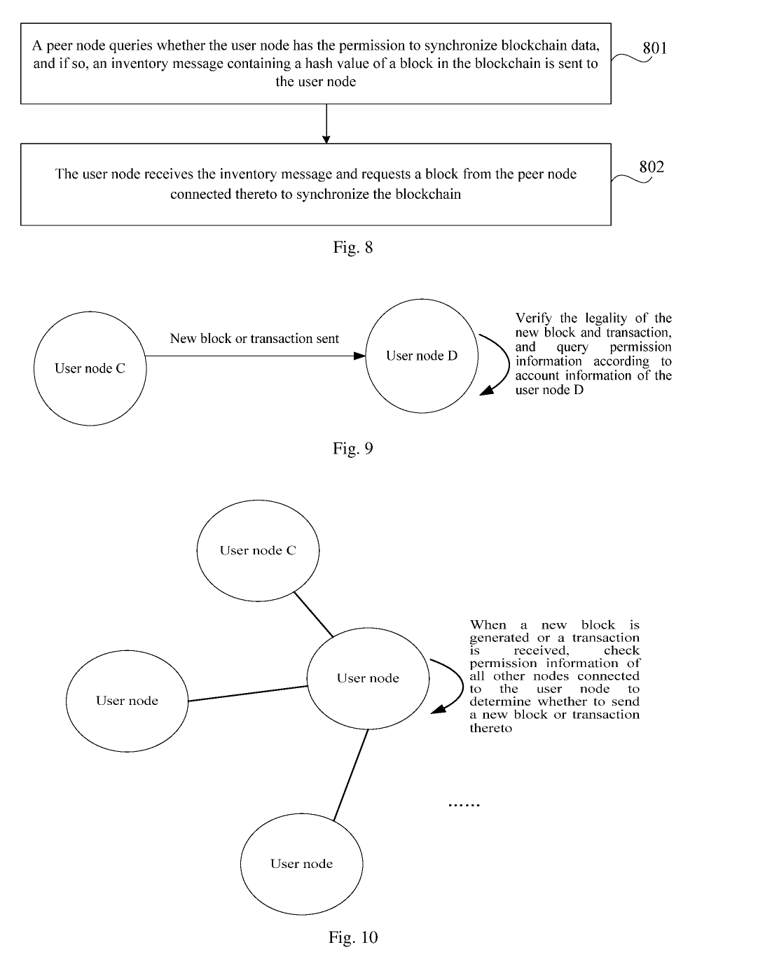

Referring to FIG. 8, in the embodiment of the present disclosure, after a user node establishes a connection with a blockchain node, that is, after accessing a blockchain network, blockchain synchronization is required. The process of synchronizing a blockchain comprises:

In step 801, a peer node queries whether an account configured to the user node has the permission to synchronize blockchain data, and if so, an inventory message containing a hash value of a block in the blockchain is sent to the user node.

In an embodiment, according to a permission information field in account attributes corresponding to an account address of the account configured to the user node, and a correspondence between account roles and permissions, whether the account configured to the user node has the permission to synchronize blockchain data is determined.

In step 802, the user node receives the inventory message and requests a block from the peer node connected thereto to synchronize the blockchain.

A user node configured with an account with the permission to synchronize blockchain data can synchronize the blockchain to local, but access to a block that is synchronized to the local is limited.

Referring to FIG. 9, in an embodiment of the present disclosure, in order to further ensure the security of block creation, when a user node C in a blockchain network receives a new block or transaction sent by a user node D, the user node C not only verifies the legality of the new block and transaction, but also queries permission information according to account information of an account configured to the user node D. It should be understood that the query of the permission information is the same as that of the above embodiment, that is, after acquiring a permission information field of a block header of a block corresponding to the account and the block stored with a correspondence between account roles and permissions, corresponding permission information is determined. The user node C determines whether to process the received new block or transaction according to the permission information of the account configured to the user node D. For example, if the account configured to the user node D does not have the permission to access a blockchain network, or the account configured to the user node D has been deleted by an administrator node and other situations, the new block or transaction sent by the user node D is not performed, thereby avoiding a security risk caused by the case where the user node D is a “no permission node”. It should be understood that the user node C may be an administrator node or any user node added to the blockchain network.

Referring to FIG. 10, in an embodiment of the present disclosure, in order to avoid a security risk caused by a “no permission node”, when a user node generates a new block or receives a transaction, permission information of accounts configured to all other nodes connected to the user node is checked to determine whether to send a new block or transaction thereto. Thus, sending a new block or transaction to “no permission node” can avoided. And when a permission of an account configured to a user node changes, for example, when an administrator node deletes the account configured to the user node, updates the permission of the account configured to the user node, etc., a block or transaction is no longer sent to some deleted user nodes to ensure the security of blockchain data.

User Node Accesses Blockchain Data

In an embodiment, a user node needs to use a corresponding access interface when accessing data synchronized to local. The access interface is used to filter data according to a permission of an account configured to the user node. A filtering rule of the access interface for data can be preset to provide an access permission to corresponding data according to the role and permission of the account configured to the user node. The access interface may also be configured to adjust the filtering rule according to permission information in the blockchain to provide the user node with an access permission to corresponding data.

Therefore, when a user node needs to access all data of a blockchain, the access interface may determine whether the user node has a corresponding permission according to permission information of an account configured to the user node. When the account configured to the user node has the corresponding permission, all data is provided to the user node.

When a user node needs to access data of the current group, the access interface may determine whether the user node has the permission to access data of the current group according to permission information of an account configured to the user node. When the account configured to the user node has the permission to access data of the current group, the data of the current group is provided to the user node.

When a user node needs to access data related to the current account, the access interface may determine whether the user node has the permission to access data related to the current account according to permission information of an account configured to the user node. When the account configured to the user node has the permission to access data related to the current account, the data related to the current account is provided to the user node.

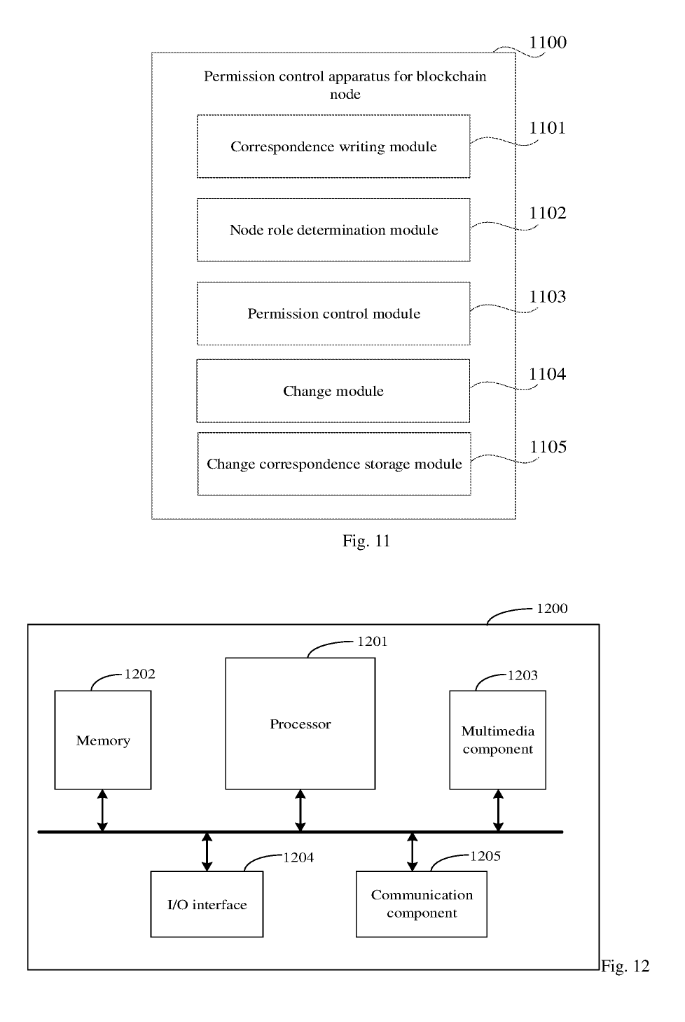

Referring to FIG. 11, an embodiment of the present disclosure further provides a permission control apparatus for a blockchain. The apparatus 1100 comprises:

a correspondence writing module 1101 configured to write a preset correspondence between account roles and permissions into a block of a blockchain;

a node role determination module 1102 configured to determine a role of a target account configured to a user node to be added to the blockchain; and

a permission control module 1103 configured to control, according to the correspondence and the role of the target account, a permission of the user node configured with the target account.

In an embodiment, the correspondence writing module 1101 is configured to write the correspondence as an account attribute of a special account into a genesis block, wherein an account address of the special account is a preset address, and the account attribute at least comprises: a permission information field including the correspondence.

In an embodiment, the apparatus 1100 further comprises:

a change module 1104 configured to change the preset correspondence between account roles and permissions; and

a change correspondence storage module 1105 configured to issue the changed correspondence between account roles and permissions to the blockchain network, so as to store the changed correspondence between account roles and permissions in a newly created block of the blockchain.

In an embodiment, the apparatus 1100 further comprises:

a request information receiving module configured to receive a request information sent by the user node, wherein the request information at least comprises an account address of the target account configured to the user node and user identification information;

a determination module configured to determine a role of the target account according to the user identification information in the request information; and

a role information writing module configured to issue transaction information including the account address and role of the target account to the blockchain network, wherein the information including the account address and role of the target account is used for writing the role of a target account user node into an account attribute corresponding to the account address of the target account user node, and the account attribute at least comprises: a permission information field including the role of the target account user node.

In an embodiment, the permission control module 1103 comprises:

a connection establishment request receiving sub-module configured to acquire an account address of the target account when receiving a P2P connection establishment request sent by the user node configured with the target account;

an account attribute acquisition sub-module configured to acquire, according to the account address of the target account, an account attribute corresponding to the account address of the target account from a blockchain;

a correspondence acquisition sub-module configured to acquire a preset correspondence between roles and permissions from a block of the blockchain;

a first permission determination sub-module configured to determine a permission of the target account according to a permission information field in the account attribute corresponding to the account address of the target account, and the correspondence;

a connection establishment sub-module configured to establish a P2P connection with the user node when the permission of the target account comprises accessing a blockchain network.

In an embodiment, the permission control module 1103 comprises:

a second permission determination sub-module configured to determine, after the user node accesses the blockchain network, whether the target account has the permission to synchronize blockchain data according to a permission information field in the account attribute corresponding to the account address of the target account, and the correspondence; and

an inventory message sending sub-module configured to send, when the permission of the target account comprises synchronizing blockchain data, to the user node an inventory message including a hash value of a block in the blockchain, the inventory message indicating the user node to synchronize blockchain data.

In an embodiment, the permission control module 1103 comprises:

a third permission determination sub-module configured to determine, when a new block or transaction needs to be sent to the user node, whether to send a new block or transaction to the user node according to the permission of the target account.

In an embodiment, the permission control module 1103 comprises:

a fourth permission determination sub-module configured to determine, when receiving a new block or transaction sent by the user node, whether to process the new block or transaction sent by the user node according to the permission of the target account.

In an embodiment, the permission control module 1103 comprises:

a fifth permission determination sub-module configured to determine, according to the correspondence and the role of the target account, an access permission of the target account to blockchain data, wherein the access permission comprises: a permission of accessing all data of the blockchain, a permission of accessing data of the current group, and a permission of accessing data related to the current account.

With regard to the apparatus in the above embodiments, the specific manners in which the respective modules perform the operations have been described in detail in the embodiments relating to the method, and will not be explained in detail herein.

Correspondingly, in an embodiment of the present disclosure, further provided is a permission control system for a blockchain node, the system comprising: an administrator node and a user node, wherein the administrator node is a node configured with an administrator account in a blockchain network, and the user node is a node configured with a corresponding account.

The administrator node is configured to write a preset correspondence between account roles and permissions into a block of a blockchain; determine a role of a target account configured to a user node to be added to the blockchain; and control, according to the correspondence and the role of the target account, a permission of the user node configured with the target account.

The system in the embodiments of the present disclosure is applicable to various fields in which blockchain data requires controlled reading, such as a financial transaction system, a hospital medical record system, and the like. The security and privacy of the blockchain data are improved by controlling permissions of user nodes; and in the embodiments of the present disclosure, not only the centerless and tamper-proof features of the blockchain can be utilized, but also the problem that the current blockchain information is completely open can be solved, thus improving the security of blockchain data.

FIG. 12 is a block diagram of a device 1200 for a permission control method for a blockchain according to an exemplary embodiment, and the device 1200 may be a node device. As shown in the figure, the device 1200 may comprise: a processor 1201, a memory 1202, a multimedia component 1203, an input/output (I/O) interface 1204, and a communication component 1205.

The processor 1201 is configured to control the overall operation of the device 1200 to complete all or part of the steps of the permission control method for a blockchain. The memory 1202 is configured to store an operating system and various types of data to support an operation at the device 1200, for example, the data may be an instruction for any application program or method operating on the device 1200, and data related to an application. The memory 1202 may be implemented by any type of volatile or non-volatile storage device or a combination thereof, such as Static Random Access Memory (SRAM), Electrically Erasable Programmable Read-Only Memory (EEPROM), Erasable Programmable Read-Only Memory (EPROM), Programmable Read-Only Memory (PROM), Read-Only Memory (ROM), magnetic memory, flash memory, disk or optical disk.

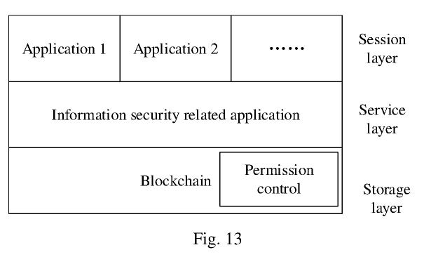

In an embodiment of the present disclosure, the operating system stored in the memory 1202 may adopt the architecture shown in FIG. 13, that is, the operating system comprises: a storage layer, a service layer, and a session layer, wherein the storage layer adopts a blockchain architecture with a node permission control to achieve the purpose of classifying information and opening permissions to users.

The multimedia component 1203 may comprises a screen and an audio component, wherein the screen may be, for example, a touch screen, and the audio component is configured to output and/or input an audio signal. For example, the audio component may comprise a microphone for receiving an external audio signal. The received audio signal may be further stored in memory 1202 or transmitted via the communication component 1205. The audio component further comprises at least one speaker for outputting an audio signal. The I/O interface 1204 provides an interface between the processor 1201 and other interface modules which may be keyboards, mouses, buttons, and the like. These buttons can be virtual buttons or physical buttons. The communication component 1205 is configured to perform a wired or wireless communication between the device 1200 and other devices. The wireless communication may be such as Wi-Fi, Bluetooth, Near Field Communication (NFC), 2G, 3G or 4G, or a combination of one or more thereof, so the corresponding communication component 1205 may comprise: a Wi-Fi module, a Bluetooth module, and a NFC module.

In an exemplary embodiment, the device 1200 may be implemented by one or more of Application Specific Integrated Circuits (ASIC), Digital Signal Processors (DSP), Digital Signal Processing Devices (DSPD), Programmable Logic Devices (PLD), Field Programmable Gate Arrays (FPGA), controllers, microcontrollers, microprocessors or other electronic components for performing the above-mentioned permission control method for a blockchain.

In another exemplary embodiment, further provided is a computer program product, wherein the computer program product comprises a computer program executable by a programmable device, and the computer program comprises a code portion for performing the above-mentioned permission control method for a blockchain when executed by the programmable device.

In another exemplary embodiment, further provided is a non-transitory computer readable storage medium comprising an instruction, such as the memory 1202 comprising an instruction that is executable by the processor 1201 of the device 1200 to perform the above-mentioned permission control method for a blockchain. For example, the non-transitory computer readable storage medium may be a ROM, a Random Access Memory (RAM), a CD-ROM, a magnetic tape, a floppy disk, and an optical data storage device, etc.

Any description of a process or method described in a flowchart or in other ways in the embodiments of the present disclosure may be understood to represent a module, fragment, or portion of a code comprising one or more executable instructions for implementing a particular logical function or step of a process; in addition, the scope of the embodiments of the present disclosure includes additional implementations in which functions may be performed in a manner that is not in the order shown or discussed, including in a substantially simultaneous manner or in reverse order, according to the functions involved, which should be understood by those skilled in the art as described in the embodiments of the present disclosure.

Other implementations of the present disclosure would have been readily conceivable to those skilled in the art after considering the description and practicing the present disclosure. The present application is intended to cover any variations, uses, or adaptations of the present disclosure, which are in accordance with the general principles of the present disclosure and include common knowledge or conventional technical means in the art that are not disclosed in the present disclosure. The description and embodiments are considered illustrative only, and the true scope and spirit of the present disclosure are indicated by the following claims.

It should be understood that the present disclosure is not limited to the precise structure described above and illustrated in the drawings, and various modifications and changes may be made without departing from its scope. The scope of the present disclosure is defined only by the appended claims.

1. A permission control method for a blockchain, comprising:
writing a preset correspondence between account roles and permissions into a block of a blockchain;
determining a role of a target account configured to a user node to be added to the blockchain; and
controlling, according to the correspondence and the role of the target account, a permission of the user node configured with the target account.

2. The method according to claim 1, wherein the step of writing a preset correspondence between account roles and permissions into a block of a blockchain comprises:
writing the correspondence as an account attribute of a special account into a genesis block,
wherein an account address of the special account is a preset address, and the account attribute at least comprises: a permission information field including the correspondence.

3. The method according to claim 2, further comprising:
changing the preset correspondence between account roles and permissions; and issuing the changed correspondence between account roles and permissions to the blockchain network, so as to store the changed correspondence between account roles and permissions in a newly created block of the blockchain.

4. The method according to claim 1, further comprising:
receiving a request information sent by the user node, wherein the request information at least comprises an account address of the target account and user identification information;
determining a role of the target account according to the user identification information in the request information; and issuing information including the account address and role of the target account to the blockchain network, wherein the information including the account address and role of the target account is used for writing the role of the target account into an account attribute corresponding to the account address of the target account, and the account attribute at least comprises: a permission information field including the role of the target account.

5. The method according to claim 4, wherein the step of controlling, according to the correspondence and the role of the target account, a permission of the user node configured with the target account comprises:
acquiring an account address of the target account when receiving a P2P connection establishment request sent by the user node configured with the target account;
acquiring, according to the account address of the target account, an account attribute corresponding to the account address of the target account from a blockchain;
acquiring a preset correspondence between roles and permissions from a block of the blockchain;
determining a permission of the target account according to a permission information field in the account attribute corresponding to the account address of the target account, and the correspondence; and establishing a P2P connection with the user node when the permission of the target account comprises accessing a blockchain network.

6. The method according to claim 5, wherein the step of controlling, according to the correspondence and the role of the target account, a permission of the user node configured with the target account comprises:
determining, after the user node accesses the blockchain network, whether the target account has the permission to synchronize blockchain data according to a permission information field in the account attribute corresponding to the account address of the target account, and the correspondence; and sending, when the permission of the target account comprises synchronizing blockchain data, to the user node an inventory message including a hash value of a block in the blockchain, the inventory message indicating the user node to synchronize blockchain data.

7. The method according to claim 4, wherein the step of controlling, according to the correspondence and the role of the target account, a permission of the user node configured with the target account comprises:
determining, when a new block or transaction needs to be sent to the user node, whether to send the new block or transaction to the user node according to the permission of the target account.

8. The method according to claim 4, wherein the step of controlling, according to the correspondence and the role of the target account, a permission of the user node configured with the target account comprises:
determining, when receiving a new block or transaction sent by the user node, whether to process the new block or transaction sent by the user node according to the permission of the target account.

9. The method according to claim 1, wherein the step of controlling, according to the correspondence and the role of the target account, a permission of the user node configured with the target account comprises:
determining, according to the correspondence and the role of the target account, an access permission of the target account to blockchain data, wherein the access permission comprises: a permission of accessing all data of the blockchain, a permission of accessing data of a current group, and a permission of accessing data related to a current account.

10.-20. (canceled)

21. A non-transitory computer readable storage medium, comprising one or more programs for performing a permission control method for a blockchain comprising:
writing a preset correspondence between account roles and permissions into a block of a blockchain;
determining a role of a target account configured to a user node to be added to the blockchain; and controlling, according to the correspondence and the role of the target account, a permission of the user node configured with the target account.

22. A node device, comprising:
a storage storing computer program; and
one or more processors configured to execute the program in the storage to perform a permission control method for a blockchain comprising:
writing a preset correspondence between account roles and permissions into a block of a blockchain;
determining a role of a target account configured to a user node to be added to the blockchain; and
controlling, according to the correspondence and the role of the target account, a permission of the user node configured with the target account.
